(19) United States
(12) Patent Application Publication
(10) Pub. No.: US 2014/0266737 A1
(43) Pub. Date: Sep. 18, 2014

(54) MONITORING SYSTEM FOR HUMAN MOVEMENTS

(71) Applicant: Theodore Caldwell, Laguna Beach, CA (US)

(72) Inventor: Theodore Caldwell, Laguna Beach, CA (US)

(21) Appl. No.: 14/211,679

(22) Filed: Mar. 14, 2014

Related U.S. Application Data
(60) Provisional application No. 61/783,884, filed on Mar. 14, 2013.

(51) Int. Cl. G08C 17/02

(52) U.S. Cl. CPC G08C 17/02
USPC 340/573.7

(57) ABSTRACT

A system can include a first device mounted to a wrist strap that includes wireless communication circuitry, sensor circuitry, and circuitry that determines hand grip information based at least in part on information output by the sensor circuitry; and a second device mounted to a waist strap that includes wireless communication circuitry, sensor circuitry, and circuitry that determines posture information based at least in part on information output by the sensor circuitry. Various other examples of devices, assemblies, systems, methods, etc., are also disclosed.

### RELATED APPLICATIONS

This application claims priority to and the benefit of a U.S. Provisional Patent Application having Ser. No. 61/783,884, filed 14 Mar. 2013, which is incorporated by reference herein including an Appendix thereof.

### TECHNICAL FIELD

Subject matter disclosed herein relates generally to monitoring of human movements.

### BRIEF DESCRIPTION OF THE DRAWINGS

A more complete understanding of the various methods, devices, assemblies, systems, arrangements, etc., described herein, and equivalents thereof, may be had by reference to the following detailed description when taken in conjunction with examples shown in the accompanying drawings where:

FIG. 1 is a diagram of an example of a system;

FIG. 2 is a diagram of an example of a monitoring device;

FIG. 3 is a diagram of an example of a monitoring device;

FIG. 4 is a table of example data from one or more monitoring devices;

FIG. 5 is a diagram of an example of a system;

FIG. 6 is a table of example data from one or more monitoring devices;

FIG. 7 is a diagram of an example of a system;

FIG. 8 is a series of diagrams of examples of monitoring;

FIG. 9 is a diagram of an example of an system;

FIG. 10 is a diagram of an example of a monitoring device;

FIG. 11 is a diagram of an example of a monitoring device;

FIG. 12 is a diagram of a monitoring device; and

FIG. 13 is a diagram of examples of syndromes and disorders.

### DETAILED DESCRIPTION

One or more multi-sensor, microprocessor based monitors may be implemented in the field of ergonomics, in particular to the pervasive problem of injuries arising out of repetitive, physically stressful motion.

As an example, an industrial safety system may be configured that can create a database for an organization's work force by means of a wrist watch instrument equipped with an array of sensors that gather real time data on each discrete upper extremity motion and the associated force of that motion as well as the orientation of the hand to the wrist. The wrist watch data, wirelessly downloaded, can be analyzed generating statistical values for frequency, force, duration and posture for the purposes of developing best practices and reducing the incidence rate on the job injuries by identifying outliers and threshold levels where the apparent risk of injury is greatest. The data may also be uploaded, for example, to a dedicated website where individual worker's profile can be aggregated into demographic groupings differentiated along dimensions of gender, age, BMI, (body mass index), and life style such as smoker, exercise frequency and the like. While a wrist watch type of device is mentioned, one or more other devices that include one or more sensors may be provided. As an example, consider a waist or lower back device, for example, to monitor posture, strain, bending, etc. As an example, where multiple devices are provided, one of the devices may be a master device and one or more others a slave device (e.g., for purposes of coordination, synchronization, data collection, data transmission, control, etc.).

Four basic elements of Ergonomics, as defined as the study of the interface between humans and their work, are: Posture, Force, Frequency and Duration. As an example, posture may be with respect to the hand to the wrist and arm; frequency may be a number of discrete motions; force may be assessed by expansion and contraction of extensor tendons at/near a pulse point in the wrist; and duration may be a physical time interval between recorded motions.

As an example, a monitor may be worn like a wrist watch. As an example, it may capture signals from its sensors (e.g., internal, external or both) and may provide digital data, for example, that may be transmitted, downloaded, etc. Such data may be analyzed, aggregated and analyzed, stored, etc. As an example, baselines and threshold levels may be systematically determined rendering a set of metrics to be used in distinguishing when workers are at risk of sustaining injuries that may result in lost time from the job, a disability claim for medical intervention, etc.

As an example, a monitor configured for wearing on a wrist may operate as follows:

Insert battery. Clock comes on and flashes the number 1 thru 9 on the display.

Next to appear on the display is 0.00 with the decimal point flashing every second. After 60 seconds the clock advances to 0.02, then 0.03 in the third minute, and so on.

The monitor registers the wearer's grip by sensing pressure on the domed shape plate on the back of the watch (e.g., and/or a strap-based sensor) that are in contact with the extensor tendons at the pulse point of the wrist, and each grip is saved in the memory and tabulated with the minute.

To recall each grip saved in the first minute, press START and then the side button labeled MODE. A thumbs-up icon appears in the icon bar along the bottom of the display.

As an example, it may be possible to scroll through all the SAVED pressure readings by pushing the side button labeled SELECT.

As an example, a monitor may capture frequency of stressful motion that can lead to cumulative trauma disorders, simultaneously measure magnitude of stress of each motion, track duration of the each interval, etc.

A small electronics assembly configured (e.g., as an example embodiment) may be placed in an inside pocket of a lumbar support belt where its pressure sensors are in contact with the small of the back (e.g., consider an assembly such as in the watch configuration). In such an example, sensors may detect and record muscle movement of the wearer. As posture changes a 3 axis accelerometer may capture and remember changes or departures from the starting position. In other words the wearer may activate the instrument while in a standing or sitting upright position. Motion involving the exertion of gripping or lifting force may activate the device. As the wearer bends or turns muscle activation may be detected. The accelerometer may equipped with a gyro so that degrees of movement can be identified. Forward and back movement as well as side to side may be noted (e.g., measured, recorded, analyzed, etc.). Movement of the arms such as that involved in reaching or lifting may be captured.

As an example, a monitor or monitors may provide for determination of correct posture, incorrect posture or both. As an example, injuries to the back producing pain and or spasms may be the result of departures from upright positioning or alignment of the back with the shoulders and hips. One may deem correct posture as lifting with a straight, unbent back. As an example, one or more monitors may detect misalignment, record instances of it over some designated period of time and the degree or severity of it through, for example, scalability predetermined in software.

One class of workers constantly at risk of lower back injury are hospital and health care workers. Moving and lifting patients off and onto gurneys, and assisting them into and out of beds and wheel chairs are functions routinely performed in the course of their duties. Frequently while executing these tasks the worker may be in an awkward and untenable posture while assisting the patient. One or more monitors may record the frequency of all such movements and further differentiate them according to how severely the lifting departed from the ideal (e.g., conducted while the back was perpendicular to the hips). As an example, an approximation of force exerted may be recorded. Assuming the instrument recording the back posture was synchronized with the grip pressure monitor worn on the wrist data on both variables could be cross tabulated.

Another envisaged application is casino dealers of cards and/or roulette. As they reach to pull in bets and chips they may be straining their backs in a manner leading to severe injury, especially if they are doing so repeatedly. As an example, one or more monitors may count a number of times a dealer reaches and whether the reach is perpendicular or oblique. Analysis of the data gathered in real time (e.g., or near real time or at a later time) may help establish benchmark or thresholds for frequency and duration of these types of movements.

As an example, data gathered from one or more sensors deployed on the back (e.g., back-mounted via a strap) may be transmitted to one or more other monitors (e.g., consider a watch). Once aggregated, it may be downloaded via a network, a port, etc. As an example, one or more monitors may communicate via a network and/or other communication means (e.g., IR, etc.). As an example, a synchronization signal may synchronize one or more monitors to provide for coordination of time stamps, etc. For example, an instant of movement of the upper extremity and the back may be accurately noted via signal/time synchronization.

As to some examples, consider: Bluetooth for short range wireless for download of data (e.g., during or after collection of data from one or more sensors in a monitoring device); USB plug-in for rechargeable battery and/or data transfer; data transmission to a second grip or pressure sensor (e.g., optionally to differentiate grip and tension pressure—two different exertions such as pinching one is same sensor for forearm muscle as well as pulse point for gripping, for example, grip with hand versus pinch—index finger thumb).

As an example, a monitor may include a dome plate wired as sensor along with a receptor in a strap. As an example, a method may include capturing gripping from two locations in the wrist. For example, consider the forearm flexor digitorum superficialis and first dorsal interosseous muscles as playing a role in pinch force matching, and the extensor digitorum and forearm flexor digitorum superficialis muscles playing a role in power force matching. Such muscles are in close proximity to where sensors may be positioned in a wrist watch type of device. As an example, a method, device, system, etc., may provide for assessment of or risk of one or more types of repetitive stress injuries (e.g., which may be due in part to pinching force, grip force or combinations thereof).

As an example, a monitor may be worn in a wristwatch manner that is configured to track up and down hand movements (e.g., consider frequency of such movements) and, for example, one or more force movements (e.g., grip force, pinch force, etc.). As an example, such a monitor may be configured to filter data, for example, to ignore those movements not germane to what may be a programmable focus task or tasks (e.g., causes of injuries, types of injuries, etc.). As an example, a method may include compiling data on those movements, etc., that may result in disability and workers' compensation claims.

As an example, a device or devices may be used in the elder care sector. Such a device or devices may include heart rate and blood pressure monitoring along with sensors for upright, prone or somewhere in between (e.g., a gyro, accelerometer, etc.).

As an example, one or more monitors may be implemented in a workplace to improve performance, reduce overtime, improve on-time delivery to customers, etc. Data may help identify performance improvements through improved workforce allocation, 5S, and standardized work.

As to LEAN in a workplace, one or more monitors may help in understanding a business, volume, 5 S, standardization, job instruction, performance, resource allocation, continuous Improvement, etc.

As an example, one or more monitors may be implemented in a workplace such as a warehouse to: Add Value Through Time & Place; Assess Storage Methods and Equipment (e.g., Pallet Storage, Small Parts Storage, Other Storage, Material Handling Methods & Equipment, Pallet Handling, Case Handling, etc.); Assess Order Picking (e.g., Streamlining Order Picking, Picking Strategies, etc.); Assess Design Procedures (e.g., Product-Volume Analysis, Storage Requirements Analysis, Selecting Equipment, etc.); Assess Warehouse Layout (e.g., Zoning & Space Requirements, Layout of The Warehouse, etc.); Assess Special Facility Requirements (e.g., Structural & Clear Height, Utilities, Fire Protection, Hazardous Materials, etc.); Assess Warehouse Management Systems; Assess Inventory Record Accuracy (e.g., Physical Inventories, Cycle Counting, Error Reduction, etc.); and Evaluate Warehouse Operations (e.g., Work Sampling, Time Standards, etc.).

As an example, a wrist worn instrument with sensors may gather repetitive stress data of the upper extremities, particularly the hand, wrist and arm. As an example, data can be downloaded to a computer and, for example, become part of an employee's personnel file. Monitoring frequency, force and posture over some given period of time may reveal how his or her work is performed and the extent to which the employee is at risk of injury resulting in a workers' comp or disability claim.

Periodically such a data file may be updated thereby creating a longitudinal data base for the purpose of detecting variations from the ergonomically correct methods or carrying out the physical demands of the job. The data can be used for a variety of purposes beyond training and injury prevention. Among the uses of the information gleaned from the data might be to detect impairment from the use of recreational drugs opioids or pain killers. Drug abuse is reaching near epidemic proportions in America's workforce. Monitoring will reveal when the frequency of the worker's motions perceptibly change, and that may indicate the need to drug test the employee and follow on with remediation. In such an example, other factors may be considered first, for example, physiological factors including stress, sleeping, psychological, stroke, disease (e.g., Parkinson's, MS, etc.), etc.

As an example, data may be stored in a distributed computing/storage environment (e.g., consider cloud computing, cloud storage, and combinations thereof). As an example, monitoring at various intervals may reveal patterns and changes in those patterns of motion and force. Such data sets may prove useful in determining, for example, legitimacy of WC & D claims. As an example, as detection of pain may be subjective and be on the basis of self-reporting, a system that includes collection of data from monitoring devices may provide objectivity or quantitative basis for validating the assertion that pain exists and, for example, that it may be a result of demands of a job.

Recalling the rationale for the Framingham Heart Study, longitudinal data sets gathered may have intrinsic value beyond those specified at the onset. Today, ergonomic data for RSI prevention is typically conducted by direct observation on site or by video recording. One or more on-body monitors may offer advantages over or in conjunction with inefficient data gathering methods (e.g., video recording where quantity of image data may be large and difficult to qualify, quantify, etc., as to movement, exertions, etc.).

As an example, a method can include monitoring RSI and/or MSD (musculoskeletal disorders) of the lower back or lumbar region. For example, sensors may detect muscle tension and alignment (e.g., via positioning on the lower back). In such an example, data may be transmitted (e.g., wired and/or wirelessly) to and stored in another device, system, etc., which may be or include a wrist worn instrument worn by the worker. As lumbar support belts may be worn by material handlers, a monitoring device may be or be included in a lumbar support belt, for example, consider a belt made out of high density neoprene which gives both warmth and support and equip it with our monitoring sensors. As an example, a data gathering system may monitor two commonly occurring types MSDs and WC & D claims.

FIG. 1 is a diagram of an example of a system 100 that includes one or more monitors such as a right monitor, a left monitor, a back monitor, etc. As shown, such monitors may monitor grip/pinch, acceleration, duration, strain/tension, posture, etc. Data may be analyzed and stored in one or more databases. Data may be used for training, health assessment, insurance (e.g., to reduce premiums, to assess value, etc.), for LEAN or one or more other purposes.

FIG. 2 is a diagram of an example of a monitoring device 200 that may monitor physiology associated with the lower back, posture, etc. Such a device may include a mesh array of sensors for position, strain, etc. Such a device may include circuitry to collect and transmit data.

FIG. 3 is a diagram of an example of monitoring devices 300. As shown, a worker such as a dealer may be fitted with one or more monitoring devices such as a waist worn device 310 and one or more wrist worn devices 320.

As an example, as shown in FIG. 3, one or both of the devices 310 and 320 may be a device such as the device 350 and include one or more of wireless communication circuitry 352, sensor circuitry 354, determination circuitry 356, accelerometer circuitry 358 and optionally other circuitry 359 (e.g., RFID chip, RFID reader circuitry, etc.). As an example, a device 370 may include wireless communication circuitry 372, a processor 373 (e.g., or processors), memory 375 and one or more modules 377 (e.g., that include processor-executable instructions that may be stored in the memory 375). As an example, the device 370 may be a computing system, which may receive information from one or more devices (e.g., via wire and/or wirelessly).

As an example, a system can include a first device mounted to a wrist strap that includes wireless communication circuitry, sensor circuitry, and circuitry that determines hand grip information based at least in part on information output by the sensor circuitry; and a second device mounted to a waist strap that includes wireless communication circuitry, sensor circuitry, and circuitry that determines posture information based at least in part on information output by the sensor circuitry. Such a system may also include a computing system that comprises wireless communication circuitry configured for communication with at least one of the wireless communication of the first device and the wireless communication circuitry of the second device. As an example, a computing system may include circuitry that monitors hand grip information and posture information. As an example, hand grip information may be ergonomic information and posture information may be ergonomic information.

As an example, at least one of a first device and a second device may include circuitry that monitors hand grip information and posture information.

As an example, a system may include a first device (see, e.g., the device 320), a second device (see, e.g., the device 310), and a third device where the third device is mounted to a wrist strap that includes wireless communication circuitry, sensor circuitry, and circuitry that determines hand grip information based at least in part on information output by the sensor circuitry. In such an example, the first and third devices may be substantially identical and optionally configured to operate as a right hand device and a left hand device, or vice versa. In such an example, the first device may determine right hand grip information and the third device may determine left hand grip information or the third device may determine right hand grip information and the first device may determine left hand grip information.

As an example, a device may include an accelerometer. As an example, a device may include one or more a strain sensors operatively coupled to the device for measurement of changes in circumference of a wrist. As an example, a device may include RFID reader circuitry. As an example, a device may include an RFID chip. As an example, an RFID chip may be implemented in a wireless non-contact system where radio-frequency electromagnetic fields can transfer data, for example, for the purposes of identifying RFID chipped objects, tracking RFID chipped objects, etc. As an example, a device such as the device 310 of FIG. 3 and/or the device 320 of FIG. 3 may include RFID reader circuitry that can identify one or more RFID chipped objects. As an example, a component or components associated with a game may include one or more RFID chips and/or one or more RFID reader circuits. As an example, a device such as the device 320 of FIG. 3 may include RFID reader circuitry and a card distribution component may include an RFID chip. As an example, a casino token (e.g., casino chip) may include an RFID chip. As an example, a device such as the device 320 of FIG. 3 may include an RFID reader that can read one or more RFID chips, which may be in a component or components of a game (e.g., in a casino chip, in a die or dice, in a card distribution component, in a table, in a portion of a table, etc.).

FIG. 4 is an information table of example data from one or more monitoring devices, for example, as worn by a blackjack dealer. The table shows movements with right hand information, left hand information and back information (e.g., swing, posture, etc.). Time is also shown, for example, where data may be time stamped to assess sequences of movement events (e.g., and time therebetween).

FIG. 5 is a diagram of an example of a system 500, which may be implemented in a casino. As shown, four tables include four dealers and a variety of players as well as cameras. Ergonomic data may be collected for the dealers and used for purposes of training, performance, exceptions, etc. As an example, time stamped data may be used to locate corresponding camera data, for example, to perform a visual review. Such examples may be used to enhance training (e.g., teach movements to avoid), to enhance performance (e.g., delays in play), to detect exceptions (e.g., potentially prohibited activity, cheating, etc.). As shown, data may be stored to a database. As mentioned, data may be aggregated for one or more purposes and optionally associated with an employee such as a dealer.

FIG. 6 is a table of example data from one or more monitoring devices, for example, as worn by a warehouse digger (e.g., consider an Amazon® warehouse digger). The table shows movements with right hand information, left hand information and back information (e.g., swing, posture, etc.). Time is also shown, for example, where data may be time stamped to assess sequences of movement events (e.g., and time therebetween).

FIG. 7 is a diagram of an example of a system 700, which may be implemented in a warehouse or other workplace. As shown, three aisle include shelves for product, which may be RFID tracked. Ergonomic data may be collected for the dealers and used for purposes of training, performance, exceptions, etc. As an example, time stamped data may be used to locate corresponding RFID data, for example, to perform coordinated review. For example, an RFID in a product may allow for identification of product size, weight, etc. Consider digger D1 carrying product P1. In such an example, movement data acquired from one or more monitoring devices fitted to digger D1 may be linked with one or more characteristics of the product P1 via RFID where the RFID links to product characteristics. For example, where RFID data for P1 indicates transport of P1 with respect to time, a time stamp of movement data for digger D1 may be used to identify the product P1 as the product being dug (e.g., pulled, lifted, carried, etc.). In such a scenario, the mass of the product and box size may be taken into account when assessing the movement data for digger D1.

As an example, a monitoring device fitted to a worker may include RFID circuitry capable of reading an RFID of a product, a workpiece, a tool, etc. In such an example, the monitoring device itself may collect data that can identify a product, a workpiece, a tool, etc. In turn, movement, duration of movement, non-movement (e.g., dynamic or static events) may be assessed with respect to the identified entity. Such an approach can go beyond mere association of entities with a worker such as Joe carried product X, Y and Z today. For example, Joe performed one lift, one turn, three grasps/re-grasps over a period of four minutes while handling product X; Joe performed two lifts, five grasps, three sways, etc. while handling product Y; etc. For example, where product X is known to weight 10 kg and have dimensions of 0.5 m×0.5 m×0.5 m, etc. Accordingly, data may be deemed as being “more scientific” as if in a controlled study—yet, the worker is merely performing a task or tasks, perhaps without being consciously aware of the detailed data collection.

As an example, a device may include an alarm (e.g., vibrate, audible, visual, etc.) that notifies a worker when a movement may place the worker at risk of injury, improper handling of an entity, etc. For example, consider a box that includes a fragile item. Monitoring of worker movement of a worker carrying that box may indicate whether the item is at risk, for example, optionally alone or in combination with a sensor in the box. As to a worker putting himself/herself at risk, consider a box with considerable mass being moved at too high of a velocity such that momentum due to dropping of the box may injure the worker or a sudden stop may injure soft tissue of the worker (e.g., as the worker tries to control the mass/momentum by grasping harder, adjusting posture, etc.).

As shown in FIG. 7, data may be used to enhance training (e.g., teach movements to avoid), to enhance performance (e.g., delays, safety), to detect exceptions (e.g., potentially loss of product, damage of product, theft, etc.). As shown, data may be stored to a database. As mentioned, data may be aggregated for one or more purposes and optionally associated with an employee such as a dealer.

FIG. 8 is a series of diagrams of examples of monitoring methods 800. As an example, a method may be implemented across a process for a product. In such an example, data may be used for a LEAN or Six Sigma type of analysis for improvement of the process. In a systems approach, the boundaries may be wide and include worker risk of injury, insurance costs, worker training, etc. As an example, ergonomic data may be input to an optimization process that may implement one or more principles of LEAN, Six Sigma, etc. In the example of the left in FIG. 8, product is packaged, inspected, carried by humans, carried by machine operated by a human (e.g., consider vibration, seating posture, etc.) and loaded into a vehicle (e.g., by human, machine, etc.). On the right in FIG. 8, a worker is at a desk and may perform various actions using his or her arms. Such a desk may include a computer, a touchscreen, a mouse, a trackball, a stylus, etc. Such a worker may be a service industry worker. Also shown is a worker performing an office task, which may include repetitive actions (e.g., handling pieces of mail, paper, etc.).

FIG. 9 is a diagram of an example of a system 900, which includes information 910, analyses 920 and 930, regulatory input/output 940 and manufacturing input/output 950. As indicated, injury prevention, management, etc., may include accessing various types of information, performing various types of analyses and taking into account regulatory, manufacturing, etc. types of constraints, inputs, outputs, etc.

FIG. 10 is a diagram of an example of a monitoring device 1000 that can include a plurality of sensors. For example, the device 1000 may include force sensors, accelerometer(s), gyro(s), etc. As an example, the device 1000 may include communication circuitry, a processor, memory, etc. As an example, such a device may be a master or a slave or otherwise configured for communication with another device (e.g., consider one or more wrist devices).

FIG. 11 is a diagram of examples of monitoring devices 1100 and 1172. Various types of circuitry are shown. Incorporated by reference herein are U.S. patent application Ser. Nos. 11/243,699 and 11/733,145.

FIG. 12 is a diagram of a monitoring device that includes a strap and a sensor or sensors configured to sense force (e.g., strain, etc.). As an example, a belt, a band, a strap, etc., may include one or more sensors.

FIG. 13 shows a diagram of a human along with various conditions. When muscular pain is assumed to be work-related, it may be classified into one of the following disorders: Occupational cervicobrachial disorders (OCD); Repetition strain injury (RSI); Cumulative trauma disorders (CTD); Overuse (injury) syndrome; and Work-related neck and upper-limb disorders.

The taxonomy of the work-related neck and upper-limb disorders demonstrates that the etiology includes external mechanical loads, which may well occur in the work place. Besides disorders in the muscle tissue itself, this category includes also disorders in other soft tissues of the musculoskeletal system. Of note is, that the diagnostic criteria may not allow to identify the location of the disorder specifically to one of these soft tissues. In fact it is likely that morphological changes at the musculo-tendinous junctions are related to the perception of muscle pain. This advocates the term fibromyalgia to be used among local muscle disorders.

In recent years, the international scientific community has focused increasingly on classification and diagnostic criteria for musculoskeletal disorders. A distinction is made between generalized and local or regional pain. Fibromyalgia syndrome is a generalized pain condition but is not considered to be work related. On the other hand, localized pain disorders are likely to be associated with specific work tasks. Myofascial pain syndrome, tension neck and rotator cuff syndrome are localized pain disorders that can be considered as work-related diseases.

While various work environments are mentioned, as an example, one or more technologies, techniques, etc. may be applied in a sports environment. For example, consider rowing where a rower wears wrist and optionally back devices. In such a manner, grip, duration, frequency, lower-back ergonomic data may be analyzed for one or more purposes.

As an example, a method can include monitoring workplace movements at least in part via a plurality of systems where each of the systems includes a first device mounted to a wrist strap that includes wireless communication circuitry, sensor circuitry, and circuitry that determines information based at least in part on information output by the sensor circuitry, and a second device mounted to a waist strap that includes wireless communication circuitry, sensor circuitry, and circuitry that determines information based at least in part on information output by the sensor circuitry; aggregating information from at least some of the plurality of systems; and analyzing the information to assess at least a portion of the monitored workplace movements. In such a method, the analyzing may assess at least a portion of the workplace movements for risk of bodily injury. As an example, a method may include analyzing to assess at least a portion of workplace movements for improving a workplace process.

As an example, a workplace process may be a workplace process in a warehouse. As an example, a method may include monitoring workplace movements in a warehouse. As an example, a method may include monitoring workplace movements in a casino. As an example, monitoring workplace movements may include monitoring workplace movements for workers with respect to tables. As an example, such tables may be or include game tables.

As an example, a method may include RFID reading, for example, to identify one or more objects, movements of objects, etc. via one or more RFID chips using RFID reader circuitry. As an example, an object may be an object fitted to a human. As an example, an object may be an object that may be carried by a human. As an example, an object may be a workstation, for example, consider a table as an object. As an example, a table may include one or more RFID chips and/or one or more RFID reader circuits. As an example, a method may include monitoring movements of objects where at least one of a plurality of systems includes an RFID chip, an RFID reader circuit or an RFID chip and an RFID reader circuit. In such an example, each of the systems may include a first device mounted to a wrist strap that includes wireless communication circuitry, sensor circuitry, and circuitry that determines information based at least in part on information output by the sensor circuitry, and a second device mounted to a waist strap that includes wireless communication circuitry, sensor circuitry, and circuitry that determines information based at least in part on information output by the sensor circuitry.

As an example, a card dealer may wear a wrist device that may include one or more RFID chips and/or one or more RFID reader circuits. As an example, a table and a dealer may identify each other, track each other, etc. As an example, identification, tracking, etc. may be via a computing system that may be configured to identify, track, etc. a plurality of objects, workers, etc. As an example, identification, tracking, etc. may be indicative of and/or associated with ergonomic information. As an example, a system may provide for monitoring objects and assessing ergonomics. Such a system may optionally provide for security (e.g., theft of objects, misplacement of objects, mislocation of people, etc.). As an example, a system may include time information, for example, to assess information with respect to time, optionally including, for example, time-based rules, etc.

### Examples of Physiology, Injuries, Etc.

The International Labour Organization (ILO) provides information on various issues associated with labor and the workplace. As an example, the ILO has produced the Encyclopaedia of Occupational Health and Safety, edited by Jeanne Mager Stellman (1998), which is incorporated by reference herein. For example, Chapter 6 of the Encyclopaedia of Occupational Health and Safety covers the musculoskeletal system. As an example, within Chapter 6, Professor Eira Viikari-Juntura, MD PhD, Helsinki, Finland, Finnish Institute of Occupational Health has written on the forearm, wrist and hand (see section 6.22 in Chapter 6). Another section covers the low-back region (see section 6.10 in Chapter 6).

Musculoskeletal disorders are among the most important occupational health problems in both developed and developing countries. These disorders affect the quality of life of most people during their lifetime. The annual cost of musculoskeletal disorders is great. In the Nordic countries, for example, it is estimated to vary from 2.7 to 5.2% of the gross national product. The proportion of all musculo-skeletal diseases that are attributable to work is thought to be approximately 30%. Thus, much is to be gained by prevention of work-related musculoskeletal disorders. To accomplish this goal, a good understanding is needed of the healthy musculoskeletal system, musculoskeletal diseases and the risk factors for musculoskeletal disorders.

Most musculoskeletal diseases cause local ache or pain and restriction of motion that may hinder normal performance at work or in other everyday tasks. Nearly all musculoskeletal diseases are work-related in the sense that physical activity can aggravate or provoke symptoms even if the diseases were not directly caused by work. In most cases, it is not possible to point to one causal factor for musculoskeletal diseases. Conditions caused solely by accidental injuries are an exception; in most cases several factors play a role. For many of the musculoskeletal diseases, mechanical load at work and leisure is an important causal factor. Sudden overload, or repetitive or sustained loading can injure various tissues of the musculoskeletal system. On the other hand, too low a level of activity can lead to deterioration of the condition of muscles, tendons, ligaments, cartilage and even bones. Keeping these tissues in good condition requires appropriate use of the musculoskeletal system.

The musculoskeletal system essentially consists of similar tissues in different parts of the body, which provide a panorama of diseases. The muscles are the most common site of pain. In the lower back the intervertebral discs are common problem tissues. In the neck and the upper limbs, tendon and nerve disorders are common, while in the lower limbs, osteoarthritis is the most important pathological condition.

In order to understand these bodily differences, it is necessary to comprehend basic anatomical and physiological features of the musculoskeletal system and to learn the molecular biology of various tissues, the source of nutrition and the factors affecting normal function. The biomechanical properties of various tissues are also fundamental. It is necessary to understand both the physiology of normal function of the tissues, and pathophysiology that is, what goes wrong. These aspects are described in the first articles for intervertebral discs, bones and joints, tendons, muscles and nerves. In the articles which follow, musculoskeletal disorders are described for the different anatomical regions. Symptoms and signs of the most important diseases are outlined and the occurrence of the disorders in populations is described. Current understanding, based on epidemiological research, of both work- and person-related risk factors is presented. For many disorders there are quite convincing data on work-related risk factors, but, for the time being, only limited data are available on exposure effect relationships between the risk factors and the disorders. Such data are needed in order to set guidelines to design safer work.

The primary approach to prevention of work-related musculoskeletal disorders is redesign of work in order to optimize the workload and make it compatible with the physical and mental performance capacity of the workers. It is also important to encourage workers to keep fit through regular physical exercise.

Serving as an electrical connection between three and a half fingers and the spinal cord, the median nerve courses down the arm and eventually through a tunnel in the wrist. The flexor tendons which bend the fingers run through this same tunnel, making the space rather tight. Carpal tunnel syndrome (CTS) occurs when the median nerve is pinched or compressed, causing a sometimes progressive disorder which may lead to wrist pain and numbness as well as tingling in the hands and certain fingers. There may be associated weakness in grip and a feeling of incoordination.

Some people are more likely to get carpal tunnel syndrome than others. For example, people who are born with small tunnels in the wrist or who have a tendency to collect fluid around their tendons and joints are more likely to have problems with pressure on the median nerve. Repetitive activities with intensive hand use—such as assembly line work or typing—can further aggravate their condition by irritating the flexor tendons, which in turn causes the tendon linings to swell and put pressure on the median nerve.

CTS also occurs more often in women than men, usually between the ages of 30 and 70 years. People who have medical problems such rheumatoid arthritis, hypothyroidism, diabetes, and renal failure are also more likely to develop carpal tunnel syndrome. These conditions create varying degrees of swelling, inflammation and susceptibility of nerves to injury.

Since office activities can sometimes exacerbate CTS, it is a good idea to examine the way you work. Activities which keep your wrists in a flexed position for long periods of time—such as resting your forearms on the edge of your desk, using a keyboard that is placed too high or too low, and repetitive filing with flexed wrists—should be modified. Lower or raise your work surface if necessary. Also, keep your wrists neutral when filing and writing for long periods. Be careful about suddenly increasing the time you spend on these activities, i.e. typing for three days straight to finish a report—even though you rarely type. Conditioning is not just important to athletes. In order to help avoid musculoskeletal ailments, everybody needs to have adequate conditioning for whatever activities they pursue.

Common symptoms of carpal tunnel syndrome include wrist pain and numbness as well as tingling in the hands, mostly in the thumb, index, middle and half of the ring finger; loss of grip strength; loss of dexterity; a pins and needles feeling that gets worse at night and occasionally swelling. The symptoms may first occur during the night, because the hand at rest allows the fluid pressure to build up on the nerve. When the condition advances, symptoms occur during waking hours as well, perhaps while driving, typing or doing other activities which involve frequent or continuous wrist flexion.

If a patient is experiencing any of the above symptoms, a physician—after a complete history and physical exam—may choose to order electrical testing of the nerve function. Electrodiagnostic testing is a useful adjunct to the physical examination in many cases of carpal tunnel syndrome. Usually performed by a neurologist, this testing has two parts. The nerve conduction test measures the speed at which the electrical signals are being carried from the brain to and from the hand via the median nerve. Electromyography evaluates the electrical activity of the muscles, looking for any abnormalities including evidence of muscle atrophy.

It is noteworthy that just the presence of abnormalities on the electrodiagnostic test does not necessarily make a diagnosis. These tests are to corroborate and clarify a clinical diagnosis of carpal tunnel syndrome made after a good history and physical examination.

The treatment for CTS varies depending on how far the disease has progressed. In the early stages, noninvasive procedures such as a removable wrist brace or anti-inflammatory medicines can be used. Braces hold the wrist straight, thereby keeping the tunnel as wide as possible and often reducing symptoms. A physician may also identify the activities which bring on the pain and suggest alternatives—such as alternating activities, taking breaks or setting up a work site to minimize irritation. Later on, a cortisone injection into the carpal tunnel can be helpful by decreasing swelling in the flexor tendons and taking pressure off nerves.

When these non-surgical treatments fail to eliminate the symptoms, surgical intervention may be necessary to decompress the median nerve and relieve the symptoms. Generally an outpatient procedure under local anesthesia, carpal tunnel surgery involves cutting the ligament at the top of the carpal tunnel to widen the tunnel and make more space for the nerve and tendons. Following the surgery, the hand is kept bandaged for several days, and elevating the hand and moving the fingers can further keep swelling to a minimum and speed recovery. Generally, depending on the pre-operative severity, the patient will be able to resume normal activities between 4 to 8 weeks after surgery, although it may take several months to reach maximum strength.

In the wrist and hand the tendons are surrounded by tendon sheaths, which are tubular structures containing fluid to provide lubrication and protection for the tendon. An inflammation of the tendon sheath is called tenosynovitis. Inflammation of the site where the muscle meets the tendon is called peritendinitis. The location of wrist tenosynovitis is at the tendon sheath area in the wrist, and the location of peritendinitis is above the tendon sheath area in the forearm. Insertion tendinitis denotes an inflammation of the tendon at the site where it meets the bone.

The terminology for the diseases of the tendon and its adjacent structures is often used loosely, and sometimes “tendinitis” has been used for all painful conditions in the forearm-wrist-hand region, regardless of the type of clinical appearance. In North America an umbrella diagnosis “cumulative trauma disorder” (CTD) has been used for all upper extremity soft tissue disorders believed to be caused, precipitated or aggravated by repetitive exertions of the hand. In Australia and some other countries, the diagnosis of “repetitive strain injury” (RSI) or “overuse injury” has been used, while in Japan the concept of “occupational cervicobrachial disorder” (OCD) has covered soft-tissue disorders of the upper limb. The two latter diagnoses include also shoulder and neck disorders.

The occurrence of tenosynovitis or peritendinitis varies widely according to the type of work. High incidences have been reported typically among manufacturing workers, such as food-processing workers, butchers, packers and assemblers. Some recent studies show that high incidence rates exist even in modern industries. Tendon disorders are more common on the back side than on the flexor side of the wrist. Upper extremity pain and other symptoms are prevalent also in other types of tasks, such as modern keyboard work. The clinical signs that keyboard workers present are, however, rarely compatible with tenosynovitis or peritendinitis.

TABLE 1
Incidence of tenosynovitis/peritendinitis in various
populations

| | Rate per 100 | |
|---|---|---|
| Study population | person-years | Reference |
| 700 Muscovite tea packers | 40.5 | Obolenskaja and |
| | | Goljanitzki 1927 |
| 12,000 car factory workers | 0.3 | Thompson et al. 1951 |
| 7,600 workers of diverse trades | 0.4 | Kivi 1982 |
| 102 male meatcutters | 12.5 | Kurppa et al. 1991 |
| 107 female sausage makers | 16.8 | Kurppa et al. 1991 |
| 118 female packers | 25.3 | Kurppa et al. 1991 |
| 141 men in non-strenuous jobs | 0.9 | Kurppa et al. 1991 |
| 197 women in non-strenuous jobs | 0.7 | Kurppa et al. 1991 |

Frequent repetition of work movements and high force demands on the hand are powerful risk factors, especially when they occur together. Generally accepted values for acceptable repetitiveness and use of force do not, however, yet exist. Being unaccustomed to hand-intensive work, either as a new worker or after an absence from work, increases the risk. Deviated or bent postures of the wrist at work and low environmental temperature have also been considered as risk factors, although the epidemiological evidence to support this is weak. Tenosynovitis and peritendinitis occur at all ages. Some evidence exists that women might be more susceptible than men. This has, however, been difficult to investigate, because in many industries the tasks differ so widely between women and men. Tenosynovitis may be due to bacterial infection, and some systemic diseases such as rheumatoid arthritis and gout are often associated with tenosynovitis. Little is known about other individual risk factors.

In tenosynovitis the tendon sheath area is painful, especially at the ends of the tendon sheath. The movements of the tendon are restricted or locked, and there is weakness in gripping. The symptoms are often worst in the morning, and functional ability improves after some activity. The tendon sheath area is tender on palpation, and tender nodes may be found. Bending of the wrist increases pain. The tendon sheath area may also be swollen, and bending the wrist back and forth may produce crepitation or crackling. In peritendinitis, a typical fusiform swelling is often visible on the backside of the forearm.

Tenosynovitis of the flexor tendons at the palmar aspect of the wrist may cause entrapment of the median nerve as it runs through the wrist, resulting in carpal tunnel syndrome.

The pathology at an acute stage of the disease is characterized by the accumulation of fluid and a substance called fibrin in the tendon sheath in tenosynovitis, and in the paratenon and between the muscle cells in peritendinitis. Later, cell growth is noticed.

It should be emphasized that tenosynovitis or peritendinitis that is clinically identifiable as occupational is found in only a minor proportion of cases of wrist and forearm pain among working populations. The majority of workers first seek medical attention with the symptom of tenderness to palpation as the sole clinical finding. It is not fully known whether the pathology in such conditions is similar to that in tenosynovitis or peritendinitis.

In the prevention of tenosynovitis and peritendinitis, highly repetitive and forceful work movements should be avoided. In addition to attention to work methods, work organizational factors (the quantity and pace of work, pauses and work rotation) also determine the local load imposed on the upper limb, and the possibility of introducing variability to work by affecting these factors should be considered as well. New workers and workers returning from a leave or changing tasks should be gradually accustomed to repetitive work.

For industrial workers with hand-intensive tasks, the typical length of sick leave due to tenosynovitis or peritendinitis has been about ten days. The prognosis of tenosynovitis and peritendinitis is usually good, and most workers are able to resume their previous work tasks.

De Quervain's tenosynovitis is a stenosing (or constricting) tenosynovitis of the tendon sheaths of the muscles that extend and abduct the thumb at the outer aspect of the wrist. The condition occurs in early childhood and at any age later. It may be more common among women than among men. Prolonged repetitive movements of the wrist and blunt trauma have been suggested as causative factors, but this has not been epidemiologically investigated.

The symptoms include local pain at the wrist and weakness of grip. The pain may sometimes extend into the thumb or up into the forearm. There is tenderness and eventual thickening on palpation at the constriction site. Sometimes nodular thickening may be visible. Bending the wrist towards the little finger with the thumb flexed in the palm (Finkelstein's test) typically exacerbates the symptoms. Some cases show triggering or snapping upon moving the thumb.

The pathological changes include thickened outer layers of the tendon sheaths. The tendon may be constricted and show enlargement beyond the site of constriction.

Stenosing tenosynovitis of the fingers. The tendon sheaths of the flexor tendons of the fingers are held close to the joint axes by tight bands, called pulleys. The pulleys may thicken and the tendon may show nodular swelling beyond the pulley, resulting in stenosing tenosynovitis often accompanied by painful locking or triggering of the finger. Trigger finger or trigger thumb have been used to denote such conditions.

The causes of trigger finger are largely unknown. Some cases that occur in early childhood are likely to be congenital, and some seem to appear after trauma. Trigger finger has been postulated to be caused by repetitive movements, but no epidemiological studies to test this have been carried out.

The diagnosis is based on local swelling, eventual nodular thickening, and snapping or locking. The condition is often encountered in the palm at the level of the metacarpal heads (the knuckles), but may occur also elsewhere and in multiple sites.

Osteoarthrosis. The prevalence of radiographically detectable osteoarthrosis in the wrist and hand is rare in the normal population under the age of 40, and is more common among men than women. After the age of 50, hand arthrosis is more prevalent among women than among men. Heavy manual labour with and without exposure to low-frequency (below 40 Hz) vibration have been associated, although not consistently, with excess prevalence of osteoarthrosis in the wrist and hand. For higher frequencies of vibration, no excess joint pathology has been reported.

Osteoarthrosis of the first joint between the base of the thumb and the wrist (carpometacarpal joint) occurs fairly commonly among the general population and is more common among women than men. Osteoarthrosis is less common in the knuckles (metacarpo-phalangeal joints), with the exception of the meta-carpophalangeal joint of the thumb. Aetiology of these disorders is not well known.

Osteoarthrotic changes are common in the joints closest to the fingertip (distal interphalangeal joints of fingers), in which the age-adjusted prevalence of radiographically detectable changes (mild to severe) in different fingers varies between 9 and 16% among the men and 13 and 22% among the women of a normal population. Distal interphalangeal osteoarthrosis can be detected by clinical examination as nodular outgrowths on the joints, called Heberden's nodes. In a Swedish population study among 55-year-old women and men, Heberden's nodes were detected in 5% of men and 28% of women. Most subjects showed changes in both hands. The presence of Heberden's nodes showed a correlation with heavy manual labor.

Joint load associated with the manipulation of tools, repetitive movements of the hand and arm possibly together with minor traumatization, loading of the joint surfaces in extreme postures, and static work have been considered as possible causative factors for wrist and hand osteoarthrosis. Although osteoarthrosis has not been considered specific to low-frequency vibration, the following factors might play a role as well: damage of the joint cartilage from shocks from the tool, additional joint load associated with a vibration-induced increase in the need for joint stabilization, the tonic vibration reflex and a stronger grip on the tool handle induced when sensitivity to touch is diminished by vibration.

The symptoms of osteoarthrosis include pain during movement in the initial stages, later also during rest. Limitation of motion in the wrist does not markedly interfere with work activities or other activities of daily living, whereas osteoarthrosis of the finger joints may interfere with gripping.

To avoid osteoarthrosis, tools should be developed that help to minimize heavy manual labour. Vibration from tools should be minimized as well.

Compartment Syndrome. The muscles, nerves and blood vessels in the forearm and hand are located in specific compartments limited by bones, membranes and other connective tissues. Compartment syndrome denotes a condition in which the intracompartmental pressure is constantly or repeatedly increased to a level at which the compartmental structures may be injured. This may occur after trauma, such as fracture or crush injury to the arm. Compartment syndrome after strenuous exertion of the muscles is a well-known disease in the lower extremity. Some cases of exertional compartment syndrome in the forearm and hand have also been described, although the cause of these conditions is not known. Neither have generally accepted diagnostic criteria nor indications for treatment been defined. The afflicted workers have usually had hand-intensive work, although no epidemiological studies on the association between work and these diseases have been published.

The symptoms of compartment syndrome include tenseness of the fascial boundaries of the compartment, pain during muscle contraction and later also during rest, and muscle weakness. In clinical examination, the compartment area is tender, painful on passive stretching, and there may be diminished sensitivity in the distribution of the nerves running through the compartment. Intracompartmental pressure measurements during rest and activity, and after activity, have been used to confirm the diagnosis, but full agreement on normal values does not exist.

Intracompartmental pressure increases when the volume of the contents increases in the rigid compartment. This is followed by an increase in venous blood pressure, a decrease in the arterial and venous blood pressure difference which in turn affects blood supply of the muscle. This is followed by anaerobic energy production and muscle injury.

The prevention of exertional compartment syndrome includes avoiding or restricting the activity causing the symptoms to a level that can be tolerated.

Ulnar Artery Thrombosis (Hypothenar Hammer Syndrome). The ulnar artery may undergo damage and subsequent thrombosis and occlusion of the vessel in the Guyon's canal on the inner (ulnar) aspect of the palm. A history of repeated trauma to the ulnar side of the palm (hypothenar eminence), such as intensive hammering or using the hypothenar eminence as a hammer, has often preceded the disease.

The symptoms include pain and cramping and cold intolerance of the fourth and fifth fingers. Neurological complaints may also be present, such as aching, numbness and tingling, but the performance of the muscles is usually normal. On clinical examination, coolness and blanching of the fourth and fifth fingers may be observed, as well as nutritional changes of the skin. The Allen's test is usually positive, indicating that after compressing the radial artery, no blood flows to the palm via the ulnar artery. A palpable tender mass may be found in the hypothenar region.

Dupuytren's Contracture. Dupuytren's contracture is a progressive shortening (fibrosis) of the palmar fascia (connective tissue joining the flexor tendons of the fingers) of the hand, leading to permanent contracture of the fingers in a flexion posture. It is a common condition in people of North-European origin, affecting about 3% of the general population. The prevalence of the disease among the men is twice that among the women, and may be as high as 20% among males aged over 60. Dupuytren's contracture is associated with epilepsy, type 1 diabetes, alcohol consumption and smoking. There is evidence for an association between vibration exposure from hand-held tools and Dupuytren's contracture. The presence of the disease has been associated also with single injury and heavy manual labour. Some evidence exists to support an association between heavy manual work and Dupuytren's contracture, whereas the role of single injury has not been adequately addressed.

The fibrotic change appears first as a node. Later the fascia thickens and shortens, forming a chordlike attachment to the digit. As the process progresses, the fingers turn to permanent flexion. The fifth and fourth fingers are usually affected first, but other fingers also may be involved. Knuckle pads may be seen on the back side of the digits.

Wrist and Hand Ganglia. A ganglion is a soft, liquid-filled small sac; ganglia represent the majority of all soft tissue tumours of the hand. Ganglia are common, although the prevalence in populations is not known. In clinical populations, women have shown a higher prevalence than men, and both children and adults have been represented. Controversy exists on the causes of ganglia. Some consider them inborn while others believe that acute or repeated trauma play a role in their development. Different opinions exist also on the development process.

The most typical location of the ganglion is at the outer aspect of the back of the wrist (dorsoradial ganglion), where it can present as a soft, clearly visible formation. A smaller dorsal ganglion may not be noticeable without flexing the wrist markedly. The volar wrist ganglion (at the palmar aspect of the wrist) is typically located on the outer side of the tendon of the radial flexor of the wrist. The third commonly occurring ganglion is located at the pulley of the finger flexor tendon sheath at the level of the knuckles. A volar wrist ganglion may cause entrapment of the median nerve in the wrist, resulting in carpal tunnel syndrome. In rare cases a ganglion may be located in the ulnar canal (Guyon's canal) in the inner palm and cause entrapment of the ulnar nerve.

The symptoms of wrist ganglia include local pain typically during exertion and deviated postures of the wrist. The ganglia in the palm and fingers are usually painful during gripping.

Disorders of Motor Control of the Hand (Writer's Cramp). Tremor and other uncontrolled movements may disturb hand functions which demand high precision and control, such as writing, assembly of small parts and playing musical instruments. The classical form of the disorder is writer's cramp. The occurrence rate of writer's cramp is not known. It affects both sexes and seems to be common in the third, fourth and fifth decades.

The causes of writer's cramp and the related disorders are not fully understood. A hereditary predisposition has been suggested. The conditions are nowadays considered as a form of task-specific dystonia. (Dystonias are a group of disorders characterized by involuntary sustained muscle contractions, causing twisting and repetitive movements, or abnormal postures.) Pathological evidence of brain disease has not been reported for patients with writer's cramp. Electrophysiological investigations have revealed abnormally prolonged activation of muscles involved in writing, and excess activation of those muscles that are not directly involved with the task.

In writer's cramp, usually painless muscle spasm appears immediately or shortly after starting to write. The fingers, wrist and hand may assume abnormal postures, and the pen is often gripped with excessive force. The neurological status may be normal. In some cases an increased tension or tremor of the affected arm is observed.

Some of the subjects with writer's cramp learn to write with the non-dominant hand, and a small proportion of these do develop cramp in the non-dominant hand as well. Spontaneous healing of writer's cramp is rare.

### CONCLUSION

Although some examples of methods, devices, systems, arrangements, etc., have been illustrated in the accompanying Drawings and described in the foregoing Detailed Description, it will be understood that the example embodiments disclosed are not limiting, but are capable of numerous rearrangements, modifications and substitutions.

What is claimed is:

1. A system comprising:
a first device mounted to a wrist strap that comprises wireless communication circuitry, sensor circuitry, and circuitry that determines hand grip information based at least in part on information output by the sensor circuitry; and
a second device mounted to a waist strap that comprises wireless communication circuitry, sensor circuitry, and circuitry that determines posture information based at least in part on information output by the sensor circuitry.

2. The system of claim 1 further comprising a computing system that comprises wireless communication circuitry configured for communication with at least one of the wireless communication of the first device and the wireless communication circuitry of the second device.

3. The system of claim 2 wherein the computing system comprises circuitry that monitors hand grip information and posture information.

4. The system of claim 1 wherein at least one of the first device and the second device comprises circuitry that monitors hand grip information and posture information.

5. The system of claim 1 wherein the first device comprises circuitry that monitors hand grip information and posture information.

6. The system of claim 1 wherein the second device comprises circuitry that monitors hand grip information and posture information.

7. The system of claim 1 further comprising a third device mounted to a wrist strap that comprises wireless communication circuitry, sensor circuitry, and circuitry that determines hand grip information based at least in part on information output by the sensor circuitry.

8. The system of claim 7 wherein the first device determines right hand grip information and wherein the third device determines left hand grip information or wherein the third device determines right hand grip information and wherein the first device determines left hand grip information.

9. The system of claim 1 wherein the first device comprises an accelerometer.

10. The system of claim 1 wherein the first device comprises a strain sensor operatively coupled to the first device for measurement of changes in circumference of a wrist.

11. The system of claim 1 comprising an ergonomic monitoring system.

12. The system of claim 1 comprising RFID circuitry to read RFID devices.

13. A method comprising:
monitoring workplace movements at least in part via a plurality of systems wherein each of the systems comprises
a first device mounted to a wrist strap that comprises wireless communication circuitry, sensor circuitry, and circuitry that determines information based at least in part on information output by the sensor circuitry, and
a second device mounted to a waist strap that comprises wireless communication circuitry, sensor circuitry, and circuitry that determines information based at least in part on information output by the sensor circuitry;
aggregating information from at least some of the plurality of systems; and
analyzing the information to assess at least a portion of the monitored workplace movements.

14. The method of claim 13 wherein the analyzing assess at least a portion of the workplace movements for risk of bodily injury.

15. The method of claim 13 wherein the analyzing assess at least a portion of the workplace movements for improving a workplace process.

16. The method of claim 15 wherein the workplace process comprises a workplace process in a warehouse.

17. The method of claim 13 wherein the monitoring workplace movements comprises monitoring workplace movements in a warehouse.

18. The method of claim 13 wherein the monitoring workplace movements comprises monitoring workplace movements in a casino.

19. The method of claim 13 wherein the monitoring workplace movements comprises monitoring workplace movements for workers with respect to tables.

20. The method of claim 13 further comprising monitoring movements of objects wherein at least one of the plurality of systems includes an RFID chip, an RFID reader circuit or an RFID chip and an RFID reader circuit.
